(19) United States
(12) Patent Application Publication
(10) Pub. No.: US 2010/0102001 A1
(43) Pub. Date: Apr. 29, 2010

(54) VALVING AND STORAGE USING MOLECULAR SIEVE MEMBRANES

(75) Inventors: John L. Falconer, Boulder, CO (US); Richard D. Noble, Boulder, CO (US); Miao Yu, Boulder, CO (US)

Correspondence Address: GREENLEE WINNER AND SULLIVAN P C, 4875 PEARL EAST CIRCLE, SUITE 200, BOULDER, CO, 80301, US

(73) Assignee: THE REGENTS OF THE UNIVERSITY OF COLORADO, A BODY, Denver, CO (US)

(21) Appl. No.: 12/529,236

(22) PCT Filed: Feb. 29, 2008
(86) PCT No.: PCT/US2008/055513

§ 371 Date: Dec. 14, 2009

Related U.S. Application Data
(60) Provisional application No. 60/892,402, filed on Mar. 1, 2007.

(51) Int. Cl. B01D 15/04

(52) U.S. Cl. 210/668; 210/679; 210/670; 210/285

(57) ABSTRACT

The invention provides chemically activated valves based on crystalline molecular sieve membranes. Adsorption of a swelling agent within the pores of the molecular sieve crystals limits transport through the membrane. Desorption of the swelling agent can re-establish transport through the membrane. This valving mechanism can be used in methods for storing and dispensing various substances.

### CROSS-REFERENCE TO RELATED APPLICATIONS

This invention claims the benefit of U.S. Provisional Application 60/892,402 filed Mar. 1, 2007 which is hereby incorporated by reference to the extent not inconsistent with the disclosure herein.

### BACKGROUND OF THE INVENTION

Zeolites are largely composed of Si, Al and O and have a three-dimensional microporous crystal framework structure largely of [SiO₄]⁴⁻ and [AlO₄]⁵⁻ tetrahedral units. To balance negative charge due to the incorporation of Al atoms in the framework, cations are incorporated into the cavities and channels of the framework. Acid hydrogen forms of zeolites have protons that are loosely attached to the framework structure. The cages, channels and cavities created by the crystal framework can permit separation of mixtures of molecules based on their effective sizes.

Different zeolites may have different Si/Al ratios and the tetrahedra can also be isostructurally substituted by other elements such as B, Fe, Ga, Ge, Mn, P, and Ti. In an extreme case, zeolite molecular sieves may have a Si/Al ratio approaching infinity. Silica molecular sieves do not have a net negative framework charge, exhibit a high degree of hydrophobicity, and have no ion exchange capacity. Silicalite-1, and silicalite-2, and Deca-dodecasil 3R (DD3R) are examples of silica molecular sieves.

Aluminophosphate (AlPO) molecular sieves are largely composed of Al, P and O and have three-dimensional microporous crystal framework structure largely of [PO₄]³⁻ and [AlO₄]⁵⁻ tetrahedral units. Silicoaluminophosphate (SAPO) molecular sieves are largely composed of Si, Al, P and O and have a three-dimensional microporous crystal framework structure largely of [PO₄]³⁻, [AlO₄]⁵⁻ and [SiO₄]⁴⁻ tetrahedral units. Molecular sieve framework structures are discussed in more detail by Baerlocher et al. (Baerlocher, Ch., et al., 2001, Atlas of Framework Structures Types, 5^{th} revised ed., Elsevier, Amsterdam).

Transport through a zeolite-type or molecular sieve membrane can be described by several parameters. As used herein, a membrane is a semi-permeable barrier between two phases that is capable of restricting the movement of molecules across it in a very specific manner. As used herein, the flux, Jᵢ, through a membrane is the number of moles of a specified component i passing per unit time through a unit of membrane surface area normal to the thickness direction. The permeance or pressure normalized flux, Pᵢ, is the flux of component i per unit transmembrane driving force. For a diffusion process, the transmembrane driving force is the gradient in chemical potential for the component (Kärger, J. Ruthven, D. M., Diffusion in Zeolites, John Wiley and Sons: New York, 1992, pp. 9-10). The selectivity of a membrane for components i over j, S_{i/j} is the permeance of component i divided by the permeance of component j. The ideal selectivity is the ratio of the permeances obtained from single gas permeation experiments. The actual selectivity (also called separation selectivity) for a gas mixture may differ from the ideal selectivity.

For two gas components i and j, a separation selectivity S_{i/j} greater than one implies that the membrane is selectively permeable to component i. If a feedstream containing both components is applied to one side of the membrane (the feed side), the permeate stream exiting the other side of the membrane (the permeate side) will be enriched in component i and depleted in component j. The greater the separation selectivity, the greater the enrichment of the permeate stream in component i.

Transport of gases through zeolite pores can be influenced by several factors. A model proposed by Keizer et al. (J. Memb. Sci., 1998, 147, p. 159) has previously been applied to SAPO-34 membranes (Poshusta et al., AlChE Journal, 2000, 46(4), pp 779-789). This model states that both molecular sizes relative to the zeolite pore and the relative adsorption strengths determine the faster permeating species in a binary mixture. This gives rise to three separation regimes where both components are able to diffuse through the molecular sieve pores. In the first region, both molecules have similar adsorption strengths, but one is larger and its diffusion is restricted due to pore walls. In the first region, the membrane is selective for the smaller molecule. In region 2, both molecules have similar kinetic diameters, but one adsorbs more strongly. In region 2, the membrane is selective for the strongly adsorbing molecule. In region 3, the molecules have significantly different diameters and adsorption strengths. The effects of each mechanism may combine to enhance separation or compete to reduce the selectivity.

Transport of gases through a crystalline molecular sieve membrane can also be influenced by any “nonzeolite pores” in the membrane structure. The contribution of nonzeolite pores to the flux of gas through a zeolite-type membrane depends on the number, size and selectivity of these pores. If the nonzeolite pores are sufficiently large, transport through the membrane can occur through Knudsen diffusion or viscous flow. For MFI zeolite membranes, it has been reported that nonzeolite pores that allow viscous and Knudsen flow decrease the selectivity (Poshusta, J. C. et al., 1999, “Temperature and Pressure Effects on CO₂ and CH₄ permeation through MFI Zeolite membranes,” J. Membr. Sci., 160, 115).

Distortion of molecular sieve frameworks upon adsorption of specific chemical species has been reported in the scientific literature. X-Ray diffraction studies report that the unit cell of MFI crystals expands approximately 0.7% in leach dimension upon n-hexane adsorption at 180 K (Morell, H. et al, 2002, Chem. Mater. 14, 2192). A change in framework symmetry has been reported for adsorption of p-xylene in H-ZSM-5 (van Konigsveld, H. et al, 1989, Acta. Cryst. B45, 423-431). Deformation of H-ZSM-5 to adsorb naphthalene has also been reported (Van Konigsveld, H et al., 1996, Micro. Mater., 159-167).

Distortion of faujasite structures has also been reported. Fonkin et al. report adsorption deformation of zeolite NaX at high pressures of xenon (1996, Russian Chemical Bulletin, 45(2), 321-323). Coker et al. reported sorption of bulky aromatic molecules into NaX (Coker, E. et al., 1998, Micro. And Meso. Mater. 261-268). Contraction of the unit cell of BaY upon adsorption of water and NO₂ was also reported (Wang, X., et al., 2004, J. Phys. Chem. B, 108, 16613-16616).

### SUMMARY OF THE INVENTION

In one aspect, the invention relates to transport of chemical species through a crystalline molecular sieve membrane comprising interlocking crystals of the molecular sieve. In a particular aspect of the invention, transport of a first component through the membrane is controlled at least in part through adsorption of a second component, which acts as a swelling agent, within the pores of the molecular sieve. Adsorption of the swelling agent causes the molecular sieve crystals to swell, thereby reducing the size of any non-zeolite pores in the membrane and reducing transport of the first component through these pores.

In an embodiment, the combination of the molecular sieve membrane and the swelling agent can form a valve. When sufficient quantities of the swelling agent are adsorbed within the pores of the molecular sieve, the valve is at least partially “closed” and transport of other components through the membrane can be restricted. The valve is chemically activated and can be designed to be chemically specific. Potential applications of such valves include separations, chemical storage, controlled release of molecules and sensors protection.

In an embodiment, the invention provides a method for reducing the transport of a first component through a molecular sieve membrane comprising zeolite pores and non-zeolite pores, wherein the method comprises the step of adsorbing a sufficient quantity of a second component in the zeolite pores to reduce transport of the first component through the non-zeolite pores of the membrane. The second component, which may be a single chemical species or a mixture of species, is capable of expanding the molecular sieve crystals. In an embodiment, the transport may be measured by the flux through the membrane. In different embodiments, the combination of the membrane and the swelling agent is selected so that the flux of the first component through the membrane in the presence of the swelling agent is less than 10%, less than 7.5%, less than 5%, less than 2.5%, less than 2%, less than 1.5%, or less than 1% of the flux in the absence of the swelling agent. In another embodiment, the transport may be measured by the permeance through the membrane. In different embodiments, the combination of the membrane and the swelling agent is selected so that the permeance of the first component through the membrane in the presence of the swelling agent is less than 10%, less than 7.5%, less than 5%, less than 2.5%, less than 2%, less than 1.5%, or less than 1% of the permeance in the absence of the swelling agent.

In an embodiment, the molecules of the first component are sized and shaped so that transport of the first component through the membrane is expected to occur mainly through the non-molecular sieve pores of the membrane. In other words, the effective size of the molecules of the first component is larger than the effective pore size of the molecular sieve. In an embodiment, the membrane is prepared with a sufficiently small average non-zeolite pore size that swelling of the molecular sieve crystals can produce a significant reduction in the transport of the first component through the membrane. FIG. 1a schematically illustrates transport of such a component (20) through an empty membrane of zeolite crystals (10); FIG. 1b schematically illustrates transport of the same component after the membrane has been exposed to the swelling agent (30).

In another embodiment, the invention provides a method for controlling the flow of a first component through a crystalline molecular sieve membrane, the method comprising the steps of:
a) providing a crystalline molecular sieve membrane comprising zeolite pores and non-zeolite pores, wherein the size of the zeolite pores is such that transport of the molecules of the first component occurs primarily through the non-zeolite pores and the permeance of the first component is greater than or equal to 1×10⁻¹⁰ mol/m²sPa;
b) adsorbing an effective amount of a second component in the zeolite pores, the second component being capable of expanding the molecular sieve crystals in at least one dimension, wherein the permeance of the first component through the membrane in the presence of the second component is less than or equal to 10%, of the permeance in the absence of the second component.

In different embodiments, the permeance of the first component through the membrane (in the absence of a swelling agent) may be greater than or equal to 1×10⁻¹⁰ mol/m²sPa, greater than or equal to 1×10⁻⁹ mol/m²sPa, greater than or equal to 1×10⁻⁸ mol/m²sPa, or greater than or equal to 1×10⁻⁷ mol/m²sPa.

In another embodiment, the effective size of the molecules of the first component is such that this component can pass through the molecular sieve pores. In this case, adsorption of swelling agent in the non-molecular sieve pores can reduce transport of the first component both through a reduction in the size of the non-molecular sieve pores and by affecting transport within the molecular sieve pores.

In an embodiment, adsorption of the swelling agent within the zeolite pores can also improve the separation selectivity of the membrane. In an embodiment, reduction of flow of chemical species through the non-zeolite pores improves the selectivity of membrane to a first component over a second component. In different embodiments, the swelling agent may be one of the components to be separated or the swelling agent may be different than the first or the second component. In different embodiments the improved separation selectivity is 20, 50, 100, 250, 500, 750, or 1000.

In an embodiment, the invention provides a method for separating molecules of a first substance from molecules of a second substance, the method comprising the steps of:
a. providing a crystalline molecular sieve membrane, the membrane having a feed side and a permeate side;
b. adsorbing a sufficient quantity of a modifying substance within the zeolite pores of the crystals, thereby improving the selectivity of the membrane to the first substance over the second substance;
c. providing a feed stream including molecules of the first and second substances at the feed side of the membrane;
d. providing a driving force sufficient for permeation of molecules of the first substance through the membrane, thereby producing a permeate stream enriched in molecules of the first substance

The valving methods of the invention may also be employed for storage of gases or other species. In an embodiment, the component may be dispensed by desorption of the swelling agent.

In an embodiment, the invention provides a method for storing and dispensing molecules of a first substance, the method comprising the steps of:
a) providing a layer of interconnected molecular sieve crystals disposed across an access port of a storage and dispensing vessel;
b) introducing molecules of the first substance into the storage and dispensing vessel;
c) placing the layer in a first state through adsorption of a sufficient quantity of molecules of a second substance within the molecular sieve pores of the crystals; and
d) placing the layer in a second state through desorption of a sufficient quantity of the adsorbed second substance
   wherein when the layer is in the first state, passage of molecules of the first substance across the layer is restricted as compared to passage of said molecules across the layer in the second state.

In one embodiment, when the layer is in the first state (“closed” or “off-state”), passage of molecules of the first substance across the layer is below a set detection limit. In another embodiment, passage of molecules of the first substance through the layer, which can also be viewed as the extent of valve leakage, is measurable but is acceptably low for a particular application.

In an embodiment, the substance or component may be stored within a pellet rather than in a conventional pressure vessel. In an embodiment, the pellet comprises a particle enclosed by a molecular sieve layer, the molecular sieve layer being suitable for use with the valving methods of the invention. Adsorption and desorption of a swelling agent within the molecular sieve pores can be used to close and open the layer to flow of the component stored within.

In an embodiment, the invention provides a pellet for storing molecules of a first substance, the pellet comprising
a. a particle comprising molecules of the first substance adsorbed within the particle; and
b. a layer comprising interconnected molecular sieve crystals and a sufficient quantity of molecules of a second substance adsorbed within the molecular sieve pores of the crystals to restrict transport of the molecules of the first substance through said layer, the layer enclosing the particle.

In an embodiment, the layer additionally comprises non-zeolite pores and adsorption of molecules of the second substance within the non-zeolite pores causes swelling of the molecular sieve crystals, thereby reducing the average size of the non-zeolite pores.

In an embodiment, the invention also provides storage and dispensing devices in which a plurality of pellets of the invention are supplied within a storage and dispensing vessel. Control of the atmosphere inside this vessel can allow control of the amount of swelling agent adsorbed within the molecular sieve layer.

### BRIEF DESCRIPTION OF THE FIGURES

FIG. 1a schematically illustrates transport of a component (20) whose kinetic diameter is larger than the zeolite pore size through an empty membrane of zeolite crystals (10). In the Figure the component (20) is shown as dimethylbutane (DMB)

FIG. 1b schematically illustrates transport of the same component after the membrane has been exposed to the swelling agent (30). In the Figures the swelling agent as shown as hexane.

FIG. 2 shows the pervaporation flux at 300 K versus kinetic diameter of the permeating molecule as pure components (open squares), DMB flux in mixtures with 4% n-hexane (solid square).

FIG. 3a shows DMB and h-hexane vapor permeation fluxes versus their feed activities for single components.

FIG. 3b shows DMB and n-hexane vapor permeation fluxes versus their feed activities in a 2% hexane/98% DMB feed mixture at 300K; the hydrocarbon partial pressures were increased while keeping the n-hexane/DMB ratio constant.

FIG. 4. Normalized helium flux at room temperature as a function of hydrocarbon activity for MFI membranes 1 and 2 of Example 2 for benzene and hexane added to the feed during permporosimetry.

FIG. 5. Isooctane flux at 313 K as a function of isooctane activity for MFI membranes 1 and 2. The flux through membrane 1 of Example 2 was multiplied by 100 to fit it on the same scale.

FIG. 6. Normalized helium flux at room temperature as a function of activity for membrane 2 of Example 2. Benzene, n-hexane, n-pentane, n-butane, propane, SF₆, and CO₂ were added to the feed during permporosimetry.

FIG. 7. Normalized helium flux at room temperature as a function of CO₂ activity during permporosimetry in membrane 1 of Example 2.

FIG. 8. Normalized helium flux at room temperature as a function of MFI crystal loading for membrane 2 of Example 2. Benzene, n-hexane, n-pentane, n-butane, propane, SF₆, and CO₂ were added to the feed during permporosimetry.

FIG. 9. Single-gas permeance, as a function of kinetic diameter, for membranes 1 and 2 of Example 2 at room temperature. The pressure drop across the membrane was 96 kPa.

FIG. 10. Single-gas H₂, N₂, and SF₆ permeances and H₂/SF₆ and N₂/SF₆ selectivity at room temperature as a function of pressure drop for membrane 1 of Example 2.

FIG. 11. Single-gas H₂, N₂, and SF₆ permeances and H₂/SF₆ and N₂/SF₆ selectivity at room temperature as a function of pressure drop for membrane 2 of Example 2.

FIG. 12. n-hexane and DMB permeances and n-hexane/DMB selectivity for a 50/50 mixture as a function of feed pressure for membrane 1 of Example 2 at room temperature.

FIG. 13. n-hexane and DMB permeances and n-hexane/DMB selectivity for a 50/50 mixture as a function of feed pressure for membrane 2 of Example 2 at room temperature.

### DETAILED DESCRIPTION

As used herein, a zeolite-type material is a molecular sieve material. A molecular sieve material has a microporous crystal framework structure of tetrahedral units having a cation in tetrahedral coordination with four oxygens. The tetrandra are assembled together such that the oxygen at each tetrahedral corner is shared with that in another tetrahedron. For zeolites, the cation is Al³⁺ or Si⁴⁺. As used herein, “microporous” refers to pore diameters less than about 2 nanometers.

Molecular sieves can be classified as small, medium, or large-pore molecular sieves based on the size of the largest oxygen rings in the structure.

Crystalline SAPO-5 has the AFI structure which contains rings of 12 oxygen atoms, 6 oxygen atoms, and 4 oxygen atoms. SAPO-5 is typically considered a large-pore molecular sieve. In contrast, crystalline SAPO-11 has the AEL structure which contains rings of 10 oxygen atoms, 6 oxygen atoms, and 4 oxygen atoms. SAPO-11 is typically considered a medium-pore molecular sieve. Structures where the largest ring contains 8 or fewer oxygen atoms are typically considered small-pore molecular sieves. Small pore molecular sieves include zeolite A, silicoaluminophosphate (SAPO)-34, and Deca-dodecasil 3R. Medium pore molecular sieves include ZSM-5, ZSM-11, and SAPO-11. Large-pore molecular sieves include SAPO-5 and SAPO-37.

In an embodiment, the molecular sieve membrane comprises molecular sieve crystals having the MFI structure (in the absence of a swelling agent). Molecular sieve materials having the MFI structure include silicalite-1, ZSM-5, and isomorphously substituted ZSM-5. In an embodiment, the ZSM-5 may be isomorphously substituted with B, Ge, Ga, Fe or combinations thereof, as disclosed in U.S. Pat. Nos. 7,074,734 and 6,767,384 to Vu et al. As used herein, the term “silicalite-1” refers to zeolite Pentasil (silicalite-1; Si-rich ZSM-5). The MFI pore size is approximately 0.6 nm and is similar to the size of may small organic molecules.

In another embodiment, the molecular sieve membrane comprises molecular sieve crystals having the FAU structure (in the absence of a swelling agent). Faujasite materials include NaX and NaY.

Molecular sieve membranes may be grown through in-situ crystallization on a porous support to form a supported membrane. As used herein, a supported membrane is a membrane attached to a support. In an embodiment, the methods and devices of the invention may utilize supported molecular sieve membranes. Gels for forming molecular sieve crystals are known to the art, but preferred gel compositions for forming membranes may differ from preferred compositions for forming loose crystals or granules. The preferred gel composition may vary depending upon the desired crystallization temperature and time.

In an embodiment, the molecular sieve membrane may be formed by providing a porous support, contacting the porous support with a molecular sieve-forming gel comprising an organic templating agent, heating the porous support and molecular sieve forming gel to form a molecular sieve layer at least in part on the surface of the porous support; and calcining the molecular sieve layer to remove the template. For some types of molecular sieves, it may be desirable to prepare the porous support by “seeding” it with molecular sieve crystals prior to contacting the support with the molecular sieve-forming gel. The term “templating agent” or “template” is a term of art and refers to a species added to the synthesis media to aid in and/or guide the polymerization and/or organization of the building blocks that form the crystal framework.

Procedures for making supported MFI-type membranes have been reported (Gues, E. R. et al., “Characterization of Zeolite (MFI) Membranes on Porous Ceramic Supports, 1992, J. Chem. Soc. Faraday Trans., 88, 3101; Yan. Y, et al. “Zeolite ZSM-5 Membranes Grown on Porous α-Al₂O₃,” 1995, JCS Chem. Commun., 2, 227; Masuda, T. at al., “Preparation of a Dense ZSM-5 Zeolite Film on the Outer of an Alumina Ceramic Filter,” 1994, Appl. Catal. 111, 143; Bakker, W. J. et al., “Single and Multi-Component Transport Through Metal Supported MFI Zeolite Membranes,” 1993, Precision Process Technology, M. P. C Weijnen and A. A. H. Drinkenburg, eds., Kluwer, Amsterdam, p. 425; Bakker, W. J. et al, “Permeation Characteristics of a Metal-Supported Silicalite-1 Zeolite Membrane,” 1996, J. Membrane Sci., 117, 57). Jia et al. (1993) J. Membrane Sci. 82:15, discloses the synthesis of silicalite membranes on ceramic disks. B-ZSM-5, Fe-ZSM-5, Ga-ZSM-5 and Ge-ZSM-5 membranes are disclosed in U.S. Pat. No. 6,767,384 to Tuan An Vu et al. as well as by Tuan et al. (Tuan, V. A., et al., “Separating Organics from Water by Pervaporation with Isomorphously-Substituted MFI Zeolite Membranes”, 2002 J. Membrane Science 196, 111-123).

Procedures for making supported FAU-type membranes have been reported by Kita et al. (Kita, H. et al., 2001, Sep. Pur. Tech., 25(1-3), 261-268).

As used herein, “zeolite pores” are pores formed by the crystal framework of a zeolite-type or molecular sieve material. The zeolite pore size(s) can be determined from the crystal structure. Although the comparison is not perfect, the kinetic diameter of a molecule can be used to estimate whether a molecule will be transported through the zeolite pores in significant quantities.

As used herein “nonzeolite pores” are pores not formed by the crystal framework. Intercrystalline pores are an example of nonzeolite pores. In an embodiment, the molecular sieve membrane contains nonzeolite pores as well as zeolite pores. In an embodiment, at least some of these non-zeolite pores are larger than the zeolite pores (as measured in the absence of adsorbed swelling agent). A variety of techniques can be used to characterize the non-zeolite pores (in the absence of adsorbed swelling agent). The average size of the non-zeolite pores can be estimated from capillary condensation of molecules which are too large to adsorb into the zeolite pores at experimental temperatures and time scales. For MFI membranes, capillary condensation of isooctane may be used to estimate the average size of the defects as described in the Examples. The non-zeolitic pore volume may be characterized by temperature-programmed desorption of molecules which are too large to adsorb into the zeolite pores at the experimental temperatures and time scales as described by Yu et al. 2007; for MFI these molecules include isooctane and DMB. The extent of flow through defects can be determined through permporosimetry. The helium flux through the membrane after introduction of an adsorbant which blocks the zeolite pores can be compared with the flux prior to introduction of the adsorbant. The ratio of these fluxes gives the percentage of He flow through defects.

In an embodiment, the molecule whose transport is to be modified is sized and shaped so that transport occurs almost exclusively through non-zeolite pores (whose average size is greater than the size of the zeolite pores). For such molecules, reduction of the average non-zeolite pore size to less than or equal to the zeolite pore size can block flow through most of the non-zeolite pores. In this case, the membrane can be viewed as being in an “off state” as regards transport of the molecule. In such an “off-state” transport need not be completely blocked; it is sufficient that the extent of leakage of the molecule through the membrane be acceptably low for a given application. For storage application, the maximum leak rate depends on the desired storage time.

When the molecular sieve membrane is to be used to provide a valve for a specific molecular species, the molecular sieve membrane is selected to provide the desired size and quantity of non-zeolite pores. When the specific molecules are shaped and sized so their transport occurs primarily or almost exclusively through non-zeolite pores at the temperatures and time scales of interest, one factor in the selection process is that the non-zeolite pores in the absence of the swelling agent provide acceptable flux levels of the molecules for a given driving force. This can be measured by the permeance (pressure driven flux) of the membrane.

A second factor in the selection process is that the reduced size of the non-zeolite pores (as produced by a particular swelling agent) provide sufficient reduction in transport of the molecules. Other membrane factors which can affect transport include the extent of crystal orientation in the membrane, the thickness of the membrane, and the presence of defects in series with the molecular sieve crystals.

The swelling agent produces expansion of at least one dimension or axis of the molecular sieve crystal. Swelling agents can be identified in several ways. In an embodiment, x-ray diffraction or optical microscopy measurements on large crystals can be used to identify agents that cause expansion for a particular molecular sieve. The amount of expansion may be dependent upon the loading of the adsorbed molecules and may also be temperature dependent. The amount of expansion may also be different along different crystallographic directions. The amount of expansion may be less than 1%. Suitable swelling agents may also be identified directly by analysis of their effect on transport through the membrane of interest. In an embodiment, the swelling agent is nonpolar. For MFI membranes, suitable swelling agents include, but are not limited to alkanes such as n-butane, n-pentane, n-hexane, n-heptane, and n-octane. In different embodiment, the alkane has greater than or equal to 2, 3, 4, or 5 carbon atoms. In other embodiments, acetone or SF₆ may be used as a swelling agent for MFI membranes. In another embodiment, combinations of molecules compounds which have been identified as swelling agents can be used to produce a swelling effect. Some of these compounds may be gases at the temperature of interest and others may be liquids. The swelling agent may be introduced into the molecular sieve crystal by a variety of methods known to the art.

In an embodiment, a sufficient amount of the swelling agent is adsorbed within the zeolite pores to affect transport of components through the membrane. The amount of the swelling agent effective to achieve a particular result can be determined experimentally. Permporosimetry measurements of helium flux as a function of the activity of the swelling agent activity can indicate the extent to which the swelling agent decreases the average non-zeolite pore size for a given membrane. These measurements can also be used to identify an effective amount of the swelling agent by identifying desirable activity ranges for the swelling agent. In an embodiment, the loading of the swelling agent within the zeolite pores is less than or equal to its saturation value. In another embodiment, the loading of the swelling agent within the zeolite pores is less than its saturation value. In other embodiments, the loading of the swelling agent within the zeolite pores is less than or equal to 1 molecule/unit cell, less than or equal to 2 molecules/unit cell, less than or equal to 4 molecules per unit cell, less than or equal to 6 molecules per unit cell, less than or equal to 8 molecules per unit cell, or less than or equal to molecules per unit cell. In different embodiments, the activity (P/Po) of the swelling agent is less than or equal to 0.005, 0.001, 0.002, 0.003, or 0.004.

The swelling agent (or agents) may adsorbed into the molecular sieve in either a static or a dynamic fashion. For example, the swelling agent may be adsorbed by exposure of the molecular sieve to an atmosphere containing the swelling agent. As another example, the swelling agent may be adsorbed by flowing the swelling agent through the membrane. In this embodiment, the swelling agent may permeate the membrane. In an embodiment, the swelling agent is adsorbed within the molecular sieve membrane through exposure of the molecular sieve to a mixture of components. For example, some amount of the swelling agent may be added to the feed of the first component to at least partially close the valve to flow of a first component. The amount of swelling agent required to be provided in the mixture may be surprisingly small. In an embodiment, the percentage of swelling agent required is less than or equal to 10%, less than or equal to 5%, less than or equal to 3%, less than or equal to 2%, less than or equal to 1%, or less than or equal to 0.5% (molar %) of the mixture. The mixture may be a liquid phase mixture or a vapor phase mixture.

The effect of a swelling agent on transport of a component through a membrane depends in part on the size of the non-zeolite pores in the membrane before and after adsorption of the swelling agent and the molecular size and shape of the component. If the non-zeolite pore size is sufficiently small compared to the amount of crystal expansion, the crystal expansion can decrease the average non-zeolite pore size to less than or equal to the zeolite pore size. For larger non-zeolite pore sizes, crystal expansion can still decrease the average non-zeolite pore size, but its effect on transport through the membrane is expected to be smaller. In an embodiment, the membrane is prepared with a sufficiently small average non-molecular sieve pore size that swelling of the crystals can produce a significant reduction in the transport of a component through the non-molecular sieve pores of the membrane.

In different embodiments, when the molecular sieve layer is in the closed or off state the permeance through the membrane is less than or equal to 1×10⁻¹⁰ mol/m²sPa, less than or equal to 1×10⁻¹¹ mol/m²sPa, or less than or equal to 1×10⁻¹² mol/m²sPa.

Transport through the membrane can be measured in several ways. Pervaporation typically involves use of a liquid phase feed and vacuum on the permeate side. Vapor phase permeation involves use of a vapor phase feed. In vapor phase permeation, the flux of a component through the membrane can depend of the activity (P/Pₒ) of the component in the mixture. Therefore, at a given temperature the pervaporation flux of a component will not necessarily be equal to the vapor permeation flux of the component.

A variety of useful molecules have effective sizes larger than that of the zeolite pores. Molecules suitable for use with the invention include, but are not limited to small organic molecules such as hydrocarbons, pesticides, pharmaceutical compounds and cleaning agents.

For molecules small enough to be transported through the zeolite pores, a greater reduction in the non-zeolite pore size will be required to block transport of these molecules through the non-zeolite pores. Transport through the zeolite pores may be affected by the presence of the adsorbed swelling agent.

In different embodiments, for MFI membranes the average non-zeolite pore size (prior to adsorption of the swelling agent) is less than or equal to 4 nm, less than or equal to 3 nm, or less than or equal to 2.5 nm as estimated from capillary condensation measurements.

In another embodiment, the invention provides a method for storing and dispensing molecules of a first substance. To store the first substance, it is introduced into a storage and dispensing vessel and then any access ports to the vessel are “closed” to restrict flow out of the vessel, thereby storing the first substance within the vessel. The access port may serve as an inlet and/or an outlet of the vessel. A molecular sieve membrane is disposed across one access port of the vessel; adsorption of the swelling agent within in molecular sieve membrane is used to restrict or block flow of the first substance through the membrane. In such an “off-state” transport through the membrane need not be completely blocked; it is sufficient that the extent of leakage of the molecule through the membrane be acceptably low for a given application. For storage application, the maximum leak rate depends on the desired storage time.

In an embodiment, the molecules of the first component are shaped and sized so that its transport occurs primarily through the non-zeolite pores of the membrane, and the storage step of the method comprises adsorbing an effective amount of a second component in the zeolite pores. In an embodiment, the second component is capable of expanding the molecular sieve crystals in at least one dimension, wherein the permeance of the first component through the membrane in the presence of the second component is less than or equal to 10% of the permeance in the absence of the second component.

To dispense the first substance, the swelling agent is desorbed from the membrane, thereby placing the membrane in an “on-state” in which transport of the first substance through the membrane is allowed. Desorption of molecules of the second substance from the pores of the molecular sieve may be accomplished in a variety of ways. In one embodiment, desorption may be accomplished by establishing pressure conditions which lead to desorption. For example, a pressure differential may be established between the interior and the exterior of the vessel. In another embodiment, desorption may be achieved by heating the molecular sieve. Desorption may also be achieved through a combination of pressure and temperature control.

In another embodiment, the layer is placed in the second state or “on-state” through adsorption of molecules of a third substance within the molecular sieve pores. In an embodiment, adsorption of the third substance produces less of a swelling effect than the second substance. In an embodiment, adsorption of the third substance can lead to shrinkage of the pores of the molecular sieve.

In another embodiment, the invention provides pellets for storage of a first substance. In this embodiment, a molecular sieve layer encloses a particle which is capable of storing a gas. Adsorption of a swelling agent in the zeolite pores of the molecular sieve allows the layer to be placed in a closed or “off-state”, thereby storing the substance within the pellet. The substance may be dispensed by desorbing the swelling agent from the zeolite pores, thereby placing the layer in a state in which transport of the substance through the membrane is allowed.

In an embodiment, the particle is porous. A variety of porous sorbents are known to the art and include molecular sieves, porous carbon, and metal-organic frameworks.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a Markush group or other grouping is used herein, all individual members of the group and all combinations and subcombinations possible of the group are intended to be individually included in the disclosure. Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general, the terms and phrases used herein have their art-recognized meaning, which can be found by reference to standard texts, journal references and contexts known to those skilled in the art. The preceding definitions are provided to clarify their specific use in the context of the invention.

### EXAMPLES

### Example 1

### B-ZSM-5 Membrane

The ability of zeolite crystal expansion to create an active nanostructure was demonstrated in the current study by preparing a polycrystalline MFI zeolite film under conditions that yielded a layer that had most of its flow through pores that were larger than 0.6 nm. The larger pores were estimated to be less than 4 nm in diameter, and they shrink to 0.6 nm or less when certain molecules adsorb in the zeolite crystals. Thus, this zeolite layer behaves as a chemically activated, and chemically specific, nano-valve that could be used to shut off flow of molecules whose kinetic diameters are larger than 0.6 nm. Controlled addition of n-hexane could also allow separations of mixtures that have molecules of different sizes, all of which are larger than 0.6 nm. A combination of gas phase and liquid feed permeation measurements were used to demonstrate this behavior.

This chemically-activated, and chemically specific nanovalve has the potential for applications in separations, chemical sensors, chemical storage, and controlled release of molecules. The preparation of the zeolite layer was not optimized for use as a nano-valve, and thus improvements in the ability of molecules like n-hexane to block fluxes of other molecules is likely. Other molecules may also expand the structure more than n-hexane and thus be even effective at lower concentrations.

### Zeolite Layer Preparation and Characterization:

An initial MFI zeolite layer was synthesized by in situ crystallization onto the inside of a tubular α-alumina support (0.2 μm pores, Pall Corp.). Because the synthesis was then repeated, the procedure is similar to secondary growth. Two ends of the support were first sealed with a glazing compound (IN1001, Duncan). The synthesis gel had a molar composition of 4.44 TPAOH:19.5 SiO2:1.55 B(OH)3:500H2O, where TPAOH is tetrapropylammonium hydroxide, a structure-directing agent (SDA). The zeolite contained boron isomorphously substituted in the framework. The synthesis procedure was similar to that described previously (V. A. Tuan, R. D. Noble, J. L. Falconer, AICHE J. 2000, 46, 1201), but the solutions were prepared with slower addition of the components, and the gel was aged at room temperature for at least 6 h.

To prepare the layer, one end of the support tube was wrapped with Teflon tape and plugged with a Teflon cap, and the inside of the support was filled with about 2 mL of the synthesis gel. The other end was then plugged with a Teflon cap and left overnight at room temperature so that the porous support could soak up almost all the synthesis gel. The tube was again filled with synthesis gel, plugged with a Teflon cap, and put into an autoclave for zeolite synthesis at 458 K for 24 h. The inside of the tube was then brushed, washed with DI water, and dried. The same procedure was repeated, except that the tube was not soaked overnight, and the support's vertical orientation in the autoclave was switched. Before calcination, the layer was impermeable to N2 at room temperature for a 138 kPa pressure drop. It was calcined at 700 K for 8 h with heating and cooling rate of 0.6 and 0.9 Kmin⁻¹, respectively to remove the SDA. A second sample was prepared by the same procedure, and it was broken and used for SEM analysis. Crystals collected from the bottom of the autoclave were used for XRD analysis.

SEM analysis of the top view of the surface of the zeolite layer showed that the crystals are approximately 15 μm wide and 0.5 μm thick. The cross sectional view showed the zeolite layer was approximately 15 μm thick. The XRD pattern for crystals collected from the bottom of the autoclave confirmed the MFI structure.

### Pervaporation and Vapor Permeation

Single-component and mixture pervaporation (liquid feed, vacuum on permeate side) was carried out at 300 K in a liquid recirculation system similar to that described previously (T. C. Bowen, J. C. Wyss, R. D. Noble, J. L. Falconer, Microporous Mesoporous Mater. 2004, 71, 199). The tube was mounted in a stainless steel module using o-ring seals, and liquid circulated its center at a flow rate of 1 Ls⁻¹. The permeate was collected in a liquid nitrogen trap, and a permeate sample was weighed every 1-2 h to determine the flux, and its composition was measured by GC. The pressure was below 0.25 kPa on the permeate side. Single-component and mixture vapor permeations were carried out in a system described previously (H. H. Funke, A. M. Argo, J. L. Falconer, R. D. Noble, Ind. Eng. Chem. Res. 1997, 36, 137). The tube was mounted in a stainless steel module using o-ring seals. Liquid organics were fed by a syringe pump to a preheated helium carrier flow (50 cm³ min⁻¹) that vaporized the hydrocarbons. Helium continuously swept the permeate side of the tube at 1 Lmin⁻¹ in order to minimize the partial pressure of permeating components, and the total pressure was the same on both sides of the tube. The feed and permeate streams were analyzed by an on-line GC. Fluxes were measured as a function of hydrocarbon feed pressures by increasing the syringe pump feed rate. Before each set of pervaporation or vapor permeation measurements, the tube was heated in air to 673 K at a rate of 0.8 Kmin⁻¹, and then held at 673 K for 4 h.

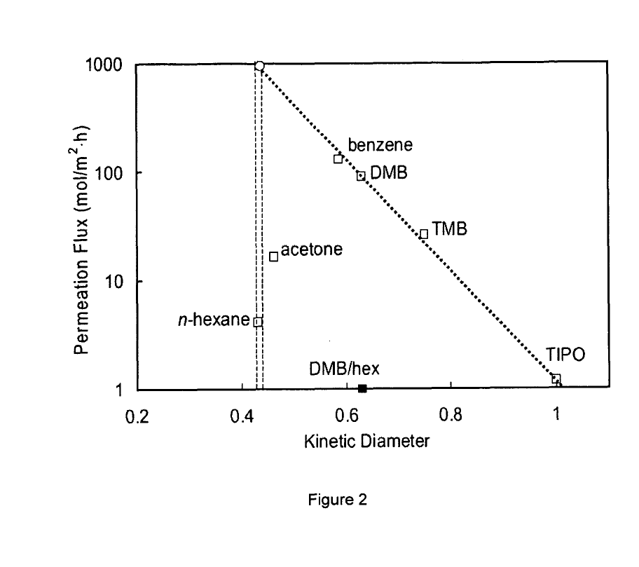

Single-component pervaporation (liquid phase feed and vacuum on the permeate side) demonstrates that almost all the flux is through pores larger than the zeolite pores. FIG. 2 shows the pervaporation flux at 300 K versus kinetic diameter of the permeating molecule as pure components (open squares), DMB flux in mixtures with 4% n-hexane (solid square). As shown in FIG. 2, the pure component fluxes for DMB, trimethylbenzne (TMB), and triisopropyl orthoformate TIPO), all of which have kinetic diameters larger than the MFI zeolite pores, exhibit an exponential decrease in flux as their kinetic diameter increases. The smaller molecules (n hexane and acetone) have lower fluxes than DMB and TMB, however. The benzene (kinetic diameter=0.585 nm) flux was 31 times the n-hexane (kinetic diameter=0.43 nm) flux, but in MFI zeolite crystals, the benzene diffusivity is 0.1% of the n-hexane diffusivity at 300 K, (Talu, 0., et al., AICHEJ. 1998, 44, 681; Xio, J. R., Chem. Eng. Sci., 1992, 47, 143) and their saturation loadings are similar (M. S. Sun, O. Talu, D. B. Shah, J. Phys. Chem. 1996, 100, 17276; K. M. A. De Meyer, S. Chempath, J. F. M. Denayer, J. A. Martens, R. Q. Snurr, G. V. Baron, J. Phys. Chem. B 2003, 107, 10 760; C. G. Pope, J. Phys. Chem. 1986, 90, 835). Similarly, the DMB (kinetic diameter=0.63 nm) flux was 21.7 times the n-hexane flux, but DMB does not enter the zeolite pores at these conditions. (M. Yu, J. L. Falconer, R. D. Noble, Langmuir 2005, 21, 7390; N.Y. Chen, W. E. Garwood, J. Catal. 1978, 52, 453). The TMB flux is 6.3 times the n-hexane flux although its kinetic diameter (0.75 nm) is even larger than that of DMB. Diffusion through the larger pores would also not be expected to exhibit the fluxes seen for n-hexane and acetone in FIG. 2; for Knudsen diffusion, the fluxes would expected to be similar, with n-hexane and DMB diffusing slightly slower than benzene, and acetone would have the highest flux. If n-hexane followed the same trend as the four larger molecules, its flux would be expected to be 1000 molm⁻²h⁻¹, which is approximately 240 times higher than measured. Similarly, the acetone flux would be expected to be 50 times higher than measured. For molecules smaller than benzene, the exponential dependence would not be expected, but the n-hexane and acetone fluxes would be expected to be higher than the benzene flux. The order of fluxes (benzene>MB>TMB>acetone>n-hexane>TIPO) can be explained if n-hexane only diffuses through MFI pores, DMB, TMB, and TIPO only diffuse through larger pores, and benzene and acetone diffuse through both types of pores, but most of their flux is through larger pores. This is possible if the nanostructure of the zeolite layer changes in the presence of n-hexane and acetone, but not in the presence of benzene, DMB, TMB, or TIPO. The following results show that when n-hexane adsorbs in MFI pores, it expands the MFI crystals sufficiently to shrink the larger pores to 0.6 nm or smaller, so that it essentially closes them. Acetone also expands the MFI crystals, but not as much.

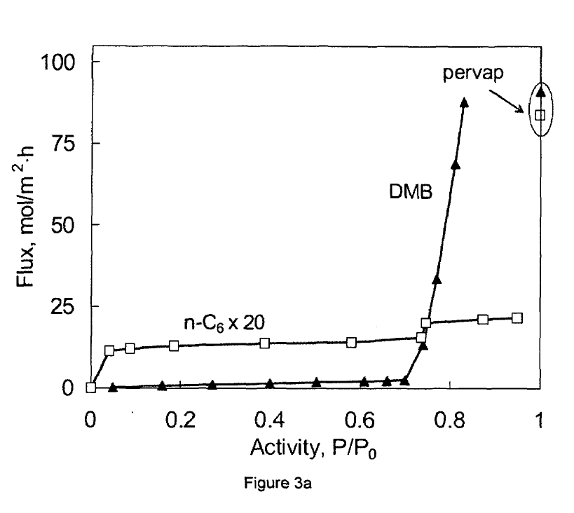

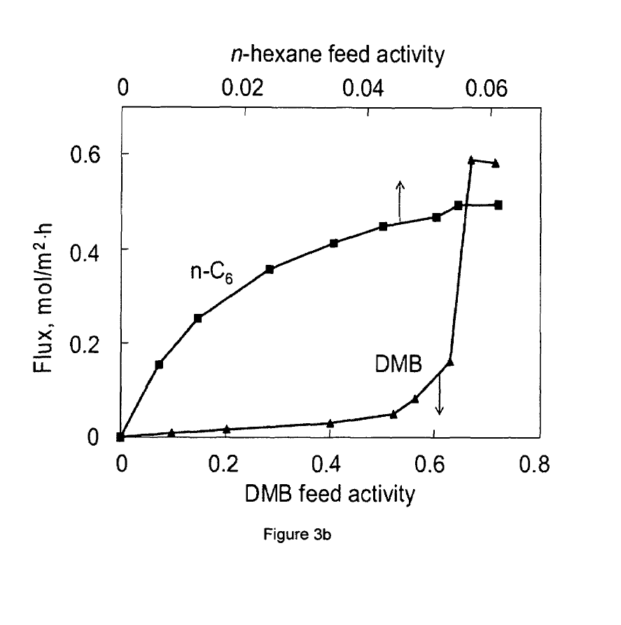

The difference in the n-hexane and DMB fluxes dependence on their feed pressures in the vapor phase directly demonstrates that n-hexane shrinks the larger pores. FIG. 3a shows DMB and h-hexane vapor permeation fluxes versus their feed activities for single components. FIG. 3b shows DMB and h-hexane vapor permeation fluxes versus their feed activities in a 2% hexane/98% DMB feed mixture at 300K; the hydrocarbon partial pressures were increased while keeping the n-hexane/DMB ratio constant. As shown in FIG. 3a, the DMB flux at 300 K was low in the vapor phase (relative to its pervaporation flux) at low DMB activities, but the flux increased a factor of 35 between an activity of 0.7 and 0.83. Further increases in the DMB feed activity did not increase the DMB flux, and instead its vapor flux was close to its pervaporation flux. The jump in the DMB flux in FIG. 3a is attributed to capillary condensation of DMB in the larger pores. These pores, since they are not part of the zeolite structure, are expected to have a range of sizes. Thus, they start filling with liquid at an activity around 0.7, and they are completely filled by an activity of 0.83, at which point they have the same loading as for a liquid feed, and thus the same flux. Below an activity of 0.7, DMB diffused through the larger pores in the gas phase and/or as an adsorbed layer on the surface. The 35-fold increase in flux may be due to the combination of a large increase in DMB concentration (the liquid density of DMB is approximately 850 times its vapor density), and a decrease in diffusivity because of diffusion in the liquid phase. The transport is more complicated than this, however, because a phase transition from liquid back to vapor takes place somewhere within the pores, since the pressure on the permeate side is too low for condensation. Note that the fluxes in FIG. 3a were measured by both increasing and decreasing the DMB feed pressure, and no hysteresis was observed. The sizes of the larger pores were calculated to be 2.5-4 nm wide using the Horvath Kawazoe (HK) potential function (G. Horvath, K. Kawazoe, J. Chem. Eng. Jpn. 1983, 16, 470) and assuming adsorbent properties similar to silica. Slit-like pores are modeled by the HK function (G. Horvath, K. Kawazoe, J. Chem. Eng. Jpn. 1983, 16, 470). Note that the exponential decrease in flux with kinetic diameter (FIG. 2) indicates the pores are smaller than 4 nm; this type decrease would not be expected if the pores were much larger than the molecules. In rather stark contrast to the DMB behavior, the jump in n-hexane flux as its pressure increased was only 0.3% of the jump in DMB flux (FIG. 3a). The n-hexane flux increased with pressure, but less than linearly, as expected for diffusion through zeolite pores at high loadings. At an activity of 0.74, the n-hexane flux underwent a step increase of about 0.2 molm⁻² h⁻¹, as shown in FIG. 3a. At these pressures, n-hexane loading in the MFI zeolite crystals is about 99% of its saturation capacity (M. S. Sun, O. Talu, D. B. Shah, J. Phys. Chem. 1996, 100, 17276). At low activity, the n-hexane flux was approximately twice the DMB flux, but at an activity of 0.83, the DMB flux was 84 times the n-hexane flux. Even when the n-hexane activity on the feed was 0.95, the n hexane flux was only 25% of its pervaporation flux, 4.2 molm⁻²h⁻¹, because the partial pressure of n-hexane on the permeate side was 30 Pa, so the loading in the zeolite crystals on the permeate side was about 80% of saturation (M. S. Sun, O. Talu, D. B. Shah, J. Phys. Chem. 1996, 100, 17276). Thus, the driving force for n-hexane permeation through MFI pores was smaller for vapor permeation than pervaporation. The jump in n-hexane flux is reproducible and reversible, and removal of n-hexane from the zeolite pores yields a zeolite layer with the same properties as the original. This small jump is attributed to capillary condensation in pores that were too large originally to be closed by expansion of the MFI crystals. That is, a few larger pores, although reduced in size as the MFI crystals expanded, were still large enough for capillary condensation. The jump in n-hexane flux was less than 0.3% of that observed for the DMB flux. Since DMB and n-hexane are expected to exhibit similar interactions with the larger pores, they should exhibit similar capillary condensation behavior. Their behavior is dramatically different, however, because almost all the larger pores were closed at low n-hexane activities. The small jump in n-hexane flux indicates that when n-hexane adsorbs in the zeolite, it stops more than 99.7% of the flow through the pores larger than 0.6 nm; that is, it closes the pores. Pervaporation fluxes for binary mixtures of DMB with n-hexane, acetone, and benzene confirm that adsorption closes the larger pores. When the feed contained 4 mol % n-hexane in DMB, the DMB flux was less than 1.2% of its pure component flux, as shown in Table 1 and FIG. 2. This low n-hexane concentration was sufficient to expand the MFI crystals and close almost 99% of the larger pores. The order that the components were added made a dramatic difference, however, in the selectivity and fluxes, as shown in Table 1. The n-hexane flux in a 4 mol % hexane/DMB mixture was about 40% of the pure hexane flux, when the film was exposed to pure hexane first and then DMB was added to dilute the hexane to 4%. In contrast, when the film was exposed to DMB first and then hexane was added to yield a 4% feed mixture, the hexane flux was only about 1% of the pure hexane flux. Changing the order of addition changed the hexane flux by a factor of 45. When DMB was added first, the membrane was not selective when hexane was added first, the n-hexane/DMB separation selectivity was 45. When hexane was added first, the separation selectivity was 900 times the ideal selectivity, demonstrating how effectively hexane closes the larger pores that DMB diffuses through. Only 0.2% n-hexane sealed more than 96% of the pores that were available for DMB flow, and decreased the DMB flux to 3.6% of its pure component flux. Similarly, 0.7 mol % hexane in TMB reduces the TMB flux to 6% of its pure component flux.

Table 1 shows results for pervaporation of single components and mixtures at 300 K.

TABLE 1

| Organics | Organics | | | |
|---|---|---|---|---|
| (order added | (order added | | | Organic/ |
| for mixture) | for mixture) | Organic Flux | DMB Flux | DMG |
| 1^{st} | 2^{nd} | (mol/m² h) | (mol/m² h) | Selectivity |
| 100% hexane | 100% DMB | 4.2 +/− 0.1 | 91.3 | 0.05 |
| 4% hexane | 96% DMB | 1.8 | 1.0 | 45 |
| 96% DMB | 4% hexane | 0.04 | 0.8 | 1.2 |
| 100% benzene | 100% DMB | 130 | 91.3 | 1.4 |
| 84% benzene | 16% DMB | 109 | 14.7 | 1.4 |
| 28% DMB | 72% benzene | 101 | 30.9 | 1.3 |
| 100% acetone | 100% DMB | 16.6 | 91.3 | 0.2 |
| 29% acetone | 71% DMB | 2.8 | 7.2 | 1.0 |
| 79% DMB | 21% acetone | 1.0 | 3.9 | 1.0 |

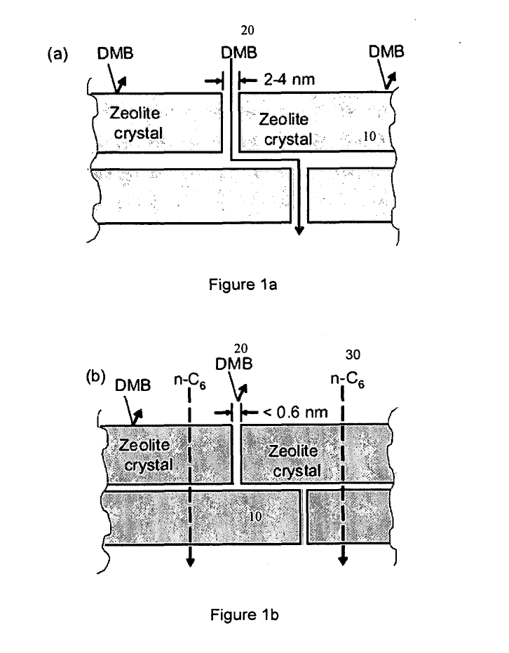

FIG. 1 is a highly-idealized, two-dimensional representation of flow through a section of the polycrystalline zeolite layer. The larger pores (the intercrystalline spaces), are exaggerated in size to more clearly demonstrate the behavior. The n-hexane flux depends on which C6 isomer was added to the feed first because larger pores exist in series with the zeolite crystals (10). Thus, when n-hexane (30) diffuses through zeolite crystals, it must desorb from one zeolite crystal, diffuse across inter-crystalline pores, and then adsorb and diffuse through another crystal. When the zeolite crystals expanded due to n-hexane adsorption, they apparently trapped DMB in the larger pores as they closed. The DMB flux (20) was essentially the same, independent of the order DMB was added, because in the presence of n-hexane, DMB only diffuses through pores that are larger than 0.6 nm and were not closed by the expanding zeolite crystals. The hexane flux was much lower when DMB was added first, because n-hexane essentially cannot transport through intercrystalline pores that are filled with DMB. The DMB cannot be readily removed from these pores because it is too large to fit into the zeolite pores at these conditions. Thus, the only transport pathways remaining are pores that were too large to be sealed by hexane adsorption. Both hexane and DMB transport through these pores, which are not selective; when DMB was added first, the selectivity was one. Acetone exhibits behavior similar to n-hexane, but as seen in Table 1, it is not as effective at closing the larger pores and blocking DMB permeation, even at much higher acetone concentrations. In contrast, even for 84% benzene in the feed, the MFI crystals did not expand enough to close the larger pores. The benzene/DMB selectivity was dose to one, independent of the order of addition, as expected for permeation through pores larger than 0.6 nm (Table 1). Neither the benzene nor the DMB flux decreased dramatically in the mixture because the pores did not shrink in the presence of benzene.

Hexane dosed the larger pores at low hexane activities, as shown in FIG. 3b for a 2% hexane, 98% DMB vapor feed. At a n-hexane activity of 0.012, the DMB flux was only 2.1% of the single-component flux at the same DMB feed activity of 0.20. Thus, the n-hexane/DMB separation selectivity was 500 in the vapor phase, whereas the ideal selectivity (single component flux ratio) was only approximately 10. That is, a polycrystalline zeolite layer with 2-4 nm pores effectively separates a difficult-to-separate hydrocarbon isomer mixture because hexane closes these pores so that almost all transport is through the zeolite crystals. Capillary condensation was observed at high DMB activities in FIG. 3b, but the DMB flux only increased to 0.6 molm⁻² which is 0.7% of the flux increase for pure DMB. Note the difference in scales between FIG. 3a and b. Hexane also exhibited a small jump in flux due to capillary condensation (FIG. 3b). The n-hexane step increase was only 6% of the DMB step increase, indicating these remaining larger pores had a selectivity of approximately 1.5. The n-hexane increase may be smaller than the value estimated from FIG. 3b, however, because measurements were not made at sufficiently small concentration increments to determine this, and thus the selectivity of these larger pores may be one. XRD measurements by others are consistent with these permeation results. Morell et al (H. Morell, K. Angermund, A. R. Lewis, D. H. Brouwer, C. A. Fyfe, H. Gies, Chem. Mater. 2002, 14, 2192) recently observed that each axis of the unit cell of the MFI crystal structure increased by approximately 1% upon n-hexane adsorption at 180 K. Therefore, for the crystals in FIG. 1, which are approximately 15×15×0.5 μm, a 1% change in the smallest dimension is 5 nm. This increase in crystal size would close 5 nm and smaller pores. In contrast, XRD measurements indicate that benzene only expands the MFI unit cell axis by 0.08% (B. F. Mentzen, F. Lefebvre, Mater. Res. Bull. 1997, 32, 813) and correspondingly, benzene adsorption did not close the pores.

Xomeritakis et al. (G. Xomeritakis, Z. P. Lai, M. Tsapatsis, Ind. Eng. Chem. Res. 2001, 40, 544) observed that adding n-hexane to a p-xylene/o-xylene mixture increased the separation factors for MFI membranes from <5 up to 30-60. Because the o-xylene flux decreased significantly but the p-xylene flux decreased slightly, they attributed this increase to preferential adsorption of n-hexane in non-zeolite pores. This increased selectivity could also be due to expansion of MFI crystals. The MFI membranes in that study were synthesized by secondary growth, and had a columnar microstructure, (A. Gouzinis, M. Tsapatsis, Chem. Mater. 1998, 10, 2497) and similar structure were observed for the membranes in the current study. This columnar structure may be necessary for the n-hexane effect reported here.

For further details, refer to Yu, M. et al, 2007, Advanced Materials, 19, 3032.

### Example 2

### B-ZSM-5 and Silicalite Membranes

For Two MFI membranes with significant flow through defects (non-zeolitic pores due to spaces between the crystals) are shown to have high ideal and mixture selectivities. Two membranes were characterized at room temperature by permporosimetry, pervaporation, vapor permeation, separations, and single-gas permeation. These measurements indicate that one membrane (B ZSM-5) has a relatively large number of 2.2-nm defects, whereas the second membrane (silicalite-1) has a smaller number of 2.8-nm defects. The relative contributions of these defects to the overall flux changed dramatically in the presence of n-alkanes and SF6. These molecules caused adsorption-induced expansion of the crystals, and this expansion shrank the defect sizes and thus changed the membrane permeation characteristics. The B-ZSM-5 membrane had 90% of its helium flux through defects at room temperature, but it had a H2/SF6 ideal selectivity as high as 260 due to SF6-induced swelling that stopped 99% of the flux through the defects. In contrast, the silicalite-1 membrane had only 9% of its helium flux through defects, but the defects were large enough that crystal swelling only decreased the flux through them by 30 percent. Thus its selectivities were lower. These studies show that n-hexane, n-pentane, n-butane, n-propane, and SF6 swell MFI crystals when they adsorb, but benzene and CO2 do not. The changes in membrane morphology due to crystal expansion not only significantly affect membrane separation ability, but also have implications on how to select appropriate characterization techniques for evaluating MFI membrane quality.

### Experimental Methods

### Membrane Preparation

Membrane 1 (silicalite-1) was prepared by hydrothermal synthesis onto porous stainless steel tubes (0.8-um pores, Pall Corp.). The permeate area was approximately 7.8 cm2. The synthesis procedure is similar to that described previously (M. Arruebo, J. L. Falconer, R. D. Noble. Separation of binary C5 and C6 hydrocarbon mixtures through MF1 zeolite membranes. J. Membr. Sci. 269 (2006) 171). The synthesis gel composition was 1.0 TPAOH:19.5 SiO2:438H2O. The outside of the support was wrapped with Teflon tape, and the autoclave was filled with the gel during the first synthesis. After hydrothermal synthesis at 458 K for 48 h, the membrane was washed and dried. Three synthesis steps were required to make the membrane impermeable to N2 at room temperature before calcination. The subsequent synthesis steps were conducted at 458 K for 24 h using the same procedure. After synthesis, the membrane was washed in distilled water and dried. It was calcined in air to remove the template, with heating and cooling rates of 0.8 and 0.9 K/min, respectively. The maximum calcination temperature was 753 K, and the membrane was held there for 8 h and then stored at 383 K under vacuum.

Membrane 2 contained boron isomorphously substituted in the framework (B-ZSM-5) and was synthesized by in situ crystallization onto the inside of a tubular α-alumina support (0.2-□m pores, Pall Corp.). The synthesis gel had a molar composition of 4.44 TPAOH:19.5 SiO2:1.55 B(OH)3:500H2O. The synthesis was similar to that described previously (V. A. Tuan, R. D. Noble, J. L. Falconer. Boron-substituted ZSM-5 membranes: Preparation and separation performance. AICHE J. 46 (2000) 1201). The resulting gel was aged at room temperature for at least 6 h. One end of the support tube was wrapped with Teflon tape and plugged with a Teflon cap, and the inside of the support was filled with about 2 mL of the synthesis gel. The other end was then plugged with a Teflon cap and left overnight at room temperature while the porous support soaked up most of the gel. The tube was again filled with synthesis gel, plugged with a Teflon cap, and put into an autoclave for hydrothermal synthesis at 458 K for 24 h. The membrane was then brushed, washed with DI water, and dried. The same synthesis procedure was repeated, except that the tube was not soaked overnight, and the membrane's vertical orientation in the autoclave was switched. The membrane was impermeable to N2 at room temperature. It was calcined at 700 K for 8 h, with heating and cooling rate of 0.6 and 0.9 K/min, respectively. An XRD pattern for crystals collected from the bottom of the autoclave confirmed the MFI structure.

### Permporosimetry

Adsorption branch porosimetry, or permporosimetry (J. Hedlund, J. Sterte, M. Anthonis, A. J. Bons, B. Carstensen, N. Corcoran, D. Cox, H. Deckman, W. De Gijnst, P. P. De Moor and others. High-flux MFI membranes. Micropor. Mesopor. Mat. 52 (2002) 179; J. Hedlund, F. Jareman, A. J. Bons, M. Anthonis. A masking technique for high quality MFI membranes. J. Membr. Sci. 222 (2003) 163), was used in an effort to determine the percentage of flow through defects. The helium flux was measured as a function of the activity of a second compound in the gas stream. For gas-phase molecules such as n butane (99.5% Airgas), propane (99.5% Airgas), SF6 (99.98%) and CO2 (99.99% Airgas), flow rates were controlled by mass flow controllers, and a pure helium stream was added to achieve the desired concentration. The activities of liquids such as n-hexane (>99.5%, Fluka), benzene (99+%, Sigma-Aldrich), and n-pentane (>99.5% Sigma-Aldrich) were controlled by saturating helium with the hydrocarbon using two liquid bubblers and mixing the saturated stream with pure helium. The hydrocarbon activity was changed by adjusting the temperature of the bubblers and the ratio of the two helium streams. The hydrocarbon activity measured by GC analysis was within 5% of that determined from the vapor pressure and the flow rates. Repeat permporosimetry measurements for both benzene and n-hexane yielded fluxes that differed by less than 5%. The membrane was sealed in a stainless steel module with o-rings. The permeate pressure was 84 kPa, and a back pressure regulator controlled the feed pressure at 185 kPa. A mass flow meter and a bubble flow meter were used to measure the helium flow rate. An activated-carbon or molecular sieve (MS 13× Dunniway) trap on the permeate line removed the adsorbate molecules from the helium stream before the flow measurements.

### Permeation Measurements

All permeation measurements were made with the membrane sealed in stainless steel modules with Viton o-rings. The pervaporation system has been described previously (T. C. Bowen, J. C. Wyss, R. D. Noble, J. L. Falconer. Measurements of diffusion through a zeolite membrane using isotopic-transient pervaporation. Micropor. Mesopor. Mat. 71 (2004) 199). A centrifugal pump circulated liquid feed through the inside of the membrane tube at approximately 1 L/min to minimize concentration polarization. The feed and membrane temperatures were adjusted with a temperature controller. The permeate side pressure was maintained below 20 Pa using a LN2 trap and a mechanical pump. Steady state fluxes were measured by condensing the permeate in the LN2 trap for 2 to 4 h. For mixtures, permeate concentrations were analyzed by a GC with a flame ionization detector. After each measurement with a given component, the membrane was calcined at 673 K for 4 h with heating and cooling rates of 0.9 K/min. Vapor permeation was carried out in a continuous flow system, as described in detail elsewhere (H. H. Funke, M. G. Kovalchick, J. L. Falconer, R. D. Noble. Separation of hydrocarbon isomer vapors with silicalite zeolite membranes. Ind. Eng. Chem. Res. 35 (1996) 1575). A syringe pump injected a liquid hydrocarbon into a preheated helium carrier stream, which then passed through a heated zone at ˜400 K for complete vaporization. A helium sweep stream was used on the permeate side. Both the feed and permeate streams were analyzed online by a GC with a flame ionization detector. A feed bypass line allowed analysis of the feed before entering the module. Bubble flow meters were used to measure flow rates. Fluxes of pure isooctane and 50/50 n-hexane/DMB mixtures as a function of feed concentration were measured at 299 K and feed and permeate pressures of 120 kPa. The feed activity was adjusted by varying the syringe feed rate and the helium carrier flow rate. Single-gas permeation of n-C4, i-C4, H2, N2, and SF6 was measured at 293 K in a dead-end mode system similar to that used previously (J. C. Poshusta, V. A. Tuan, J. L. Falconer, R. D. Noble. Synthesis and permeation properties of SAPO-34 tubular membranes. Ind. Eng. Chem. Res. 37 (1998) 3924). Feed pressures were varied between 200 and 680 kPa and the permeate pressure was approximately 84 kPa. Gas fluxes were measured with mass flow meters and a bubble flow meter. Between each measurement, the membrane was calcined at 673 K for 4 h, and the system was then evacuated and flushed with the test gas. The i-butane was 99.5% from Airgas.

### Results and Discussion

The two MFI membranes were synthesized on different supports, used slightly different preparation procedures, and had different compositions (silicalite-1 and. B-ZSM-5). Thus, they might be expected to have different microstructures and morphologies, and permeation measurements described below illustrate how their microstructures were changed by adsorption.

These microstructure differences are also useful for demonstrating how MFI membranes can be characterized. All characterizations were done at room temperature.

### Row Through Defects: Permporosimetry

The helium flux through the zeolite pores of a WI membrane can be blocked by molecules adsorbed in the pores (J. C. Poshusta, V. A. Tuan, J. L. Falconer, R. D. Noble. Synthesis and permeation properties of SAPO-34 tubular membranes. Ind. Eng. Chem. Res. 37 (1998) 3924, J. Hedlund, F. Jareman, A. J. Bons, M. Anthonis. A masking technique for high quality MFI membranes. J. Membr. Sci. 222 (2003) 163), and permporosimetry with benzene (FIG. 1) shows that the fraction of helium blocked was significantly different for the two membranes. Note that the normalized helium flux is plotted on a log scale in FIG. 1 so the two membranes can be compared. For membrane 1, only 9% of the helium flow remained after introducing benzene, whereas for membrane 2, 90% of the helium flow remained. That is, at room temperature, 9% of the helium flux is through defects in membrane 1, but 90% of the helium flux is through defects in membrane 2. Benzene was used because previous measurements by showed that it did not significantly swell MFI crystals, and thus it did not shrink or close the defects.

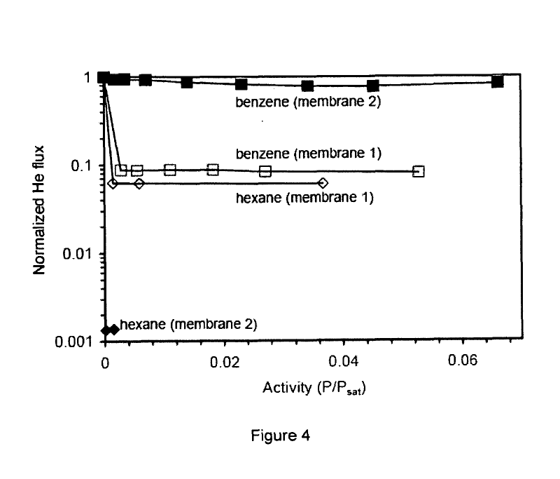

These two membranes exhibited dramatically different behavior when permporosimetry was carried out with n-hexane, as shown in FIG. 4. For membrane 2, crystal expansion by n-hexane reduced the helium flow through the defects by almost three orders of magnitude, from 90% of the total flow to about 0.14% (Table 2). Although a smaller fraction of the helium flux was through the defects of membrane 1 (as determined by benzene permporosimetry), n-hexane adsorption only reduced flow through those pores by about a third, from 9% to 6.5% of the total flow. Apparently, MFI crystal expansion by n-hexane was not sufficient to close off flow through the defects in membrane 1. Even though a much larger fraction of helium flow was through defects in membrane 2, the average defect size was apparently smaller than in membrane 1, and the defects were small enough that MFI crystal expansion blocked most of the flow through them. Thus, permporosimetry using n-hexane or benzene indicates completely different membrane qualities. These differences are useful for demonstrating the differences in structure and behavior that are possible for MFI membranes and for showing how MFI membranes should be characterized. Even though membrane 2 had most of its flow through defects, it has more potential for separations of mixtures that contain n-hexane or other molecules that swell the crystals, as discussed below. Table 2 presents room temperature results.

TABLE 2

| | Membrane 1 | Membrane 2 |
|---|---|---|
| Measurement | Silicalite | B-ZSM-5 |
| % He flow through | 9% | 90% |
| defects | | |
| % He flow through | 4.5% | <0.14% |
| defects when n-hexane | | |
| adsorbed | | |
| Benzene pervaporation | 0.32 | 6.7 |
| flux (kg/m2 h) | | |
| Helium permeance | 1.5 | 5.1 |
| (mol/m2 s Pa) × 10⁷ | | |
| Non-zeolitic pore size | 3 nm | 2 nm |
| (from capillary | | |
| condensation) | | |
| N2/SF6 ideal selectivity | 32-45 | 90-180 |
| (200 to 680 kPa feed) | | |
| Non-zeolitic pore size | 32-45 | 160-260 |
| (from capillary | | |
| condensation | | |
| n-butane/i-butane ideal | 8 | 8 |
| selectivity (200 kPa | | |
| feed) | | |
| n-hexane/DMB | 60 | 260 |
| separation selectivity at | | |
| 0.8 kPa | | |
| isomer feed pressure | | |

### Permeation Through Defects: Liquid Feeds

Pervaporation also showed that the two membranes had significantly different fractions of their fluxes through defects, and that n-hexane adsorption had a much larger effect on membrane 2 than membrane 1. Indeed, n-hexane adsorption changed membrane 2 sufficiently that it exhibited inverse selectivity for pure components; that is, a larger isomer permeated significantly faster than a smaller one. Under pervaporation conditions at room temperature, DMB only permeates at a measurable rate through defects. As shown in Table 3, the DMB flux through membrane 2 was 70 times that through membrane 1, and the benzene flux through membrane 2 was 21 times that through membrane 1, but the n-hexane flux for membrane 2 is ⅙ of the flux for membrane 1. That is, the DMB flux through membrane 2 is 160 times the n-hexane flux, and the benzene flux is almost 100 times the n-hexane flux (Table 3). In contrast, n hexane permeates 2.5 times faster than DMB and 1.3 times faster than benzene through membrane 1. That is, the n-hexane/DMB ideal selectivities at high loadings differ by a factor of 400 for the two membranes. These dramatic differences demonstrate that most of the defects are not available for nhexane permeation through membrane 2. Moreover, adding only 1.6% n-hexane to a benzene feed reduced the benzene flux to 2% of its single component flux for membrane 2 (Table 3). Adding nhexane to benzene had a much smaller effect on membrane 1; the benzene flux was 38% of the single-component benzene flux. The single-component n-hexane flux is almost six times higher in membrane 1 than membrane 2. These results show that membrane 2 had much more flow through defects, but those defects were sealed much better when n-hexane adsorbed. This is consistent with the permporosimetry results; the defects are larger for membrane 1, and thus the n-hexane flux is higher because swelling did not close the defects. Table 3 presents room temperature results.

TABLE 3

| | Flux (kg/m²h) | Flux (kg/m²h) |
|---|---|---|
| Feed | Membrane 1 | Membrane 2 |
| n-hexane | 0.41 | 0.07 |
| 2,2-dimethylbutane | 0.16 | 11.2 |
| Benzene | 0.32 | 6.7 |
| n-hexane in | 0.024 | 0.0026 |
| 1.6% n-C6/98.4% | | |
| benzene mixture | | |
| benzene in | 0.13 | 0.12 |
| 1.6% n-C6/98.4% | | |
| benzene mixture | | |
| Separation selectivity (n- | 8.3 | 1.1 |
| C6/benzene) | | |

### Sizes of Defects

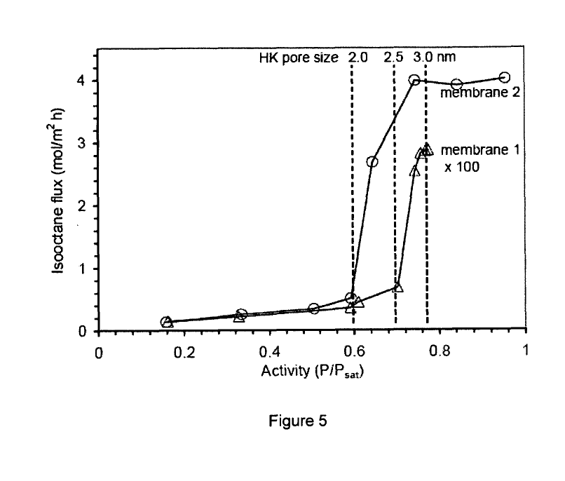

The average sizes of the defects were estimated from capillary condensation of isooctane, which is too large to adsorb in the MFI pores. FIG. 5 shows vapor permeation fluxes o fisooctane, as a function of its activity in the feed, for the two membranes. Capillary condensation of DMB and isooctane has been used previously to estimate defect size. It was observed that the flux of DMB or isooctane increased by an order of magnitude or more over a narrow activity range at high activities. This was attributed to condensation in the defects; condensation increased the concentration in the defects by as much as three orders of magnitude, but decreased the diffusivity from a gas phase to a liquid phase value. Apparently the diffusivity did not decrease as much as the concentration increased.

As seen in FIG. 5, membranes 1 and 2 exhibited similar behavior, with almost an order of magnitude increase in flux over a narrow activity range. The membranes had two significant differences:

1) The isooctane flux through membrane 2 was more than two orders of magnitude higher than that through membrane 1. Similarly the DMB pervaporation flux (Table 3) was almost two orders of magnitude higher for membrane 2.

2) Capillary condensation of isooctane occurred at a significantly lower activity for membrane 2, indicating that membrane 2 has smaller defects. The average sizes estimated from the Horvath-Kawazoe (H-K) potential function for slit pores (G. Horvath, K. Kawazoe. Method for the Calculation of Effective Pore-Size Distribution in Molecular-Sieve Carbon. Journal of Chemical Engineering of Japan 16 (1983) 470) are about 2.8 nm for membrane 1 and 2.2 nm for membrane 2.

These results are consistent with the permporosimetry results, which showed that n-hexane adsorption decreased the helium flux through defects for membrane 2 by three orders of magnitude, but it only reduced the helium flux by about 30% for membrane 1, as might be expected if the defects are larger for membrane 1.

Molecules that Swell MFI Crystals

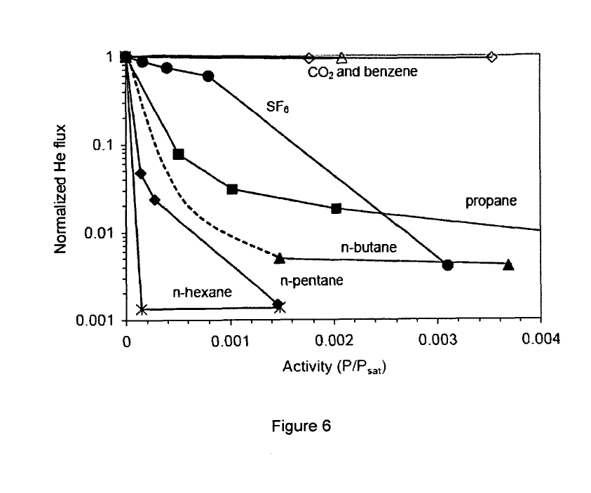

Permporosimetry measurements indicate that molecules besides n-hexane also cause MFI crystals to swell. As shown in FIG. 6, even low activities (<0.005) of n-propane, n-butane, npentane, and SF6 decreased helium permeance through the defects in membrane 2 by two orders of magnitude or more. For n-alkanes the helium flux was lower at a given activity as the carbon number increased; this trend is readily seen for an activity around 0.0015. As the carbon number increased, the n-alkane loading increased at a given activity, and at higher alkane loadings the crystals apparently swell more and thus block more of the helium flow. Note that even at the lowest activities used for n-butane and n-hexane, the alkane loadings were high enough to close off most defects. The expected helium flux in the presence of n-butane is shown at low activities in FIG. 6 for clarity (dashed line). Recent XRD and microscopy studies in our laboratory also show that nbutane, n-pentane, n-hexane, n-heptane, and n-octane swell MFI crystals, but benzene does not. We also observed with TPD that n-octane swelled MFI crystals and decreased the pore volume.

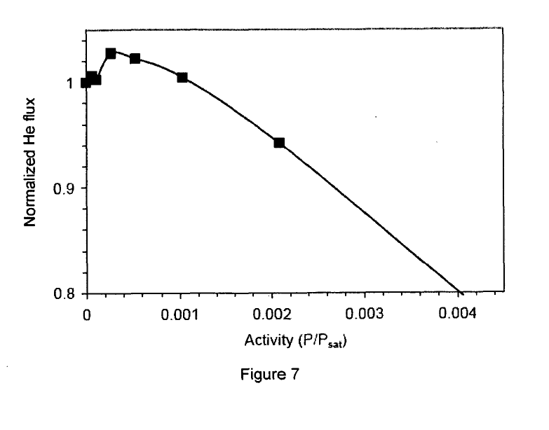

In contrast to the alkanes, SF6 decreased the helium flux only slightly at low activities, but at a SF6 activity above 0.003, only 0.4% of the helium flux remained, as shown in FIG. 6. Carbon dioxide had little effect on the flux through defects. At an activity of 0.004, CO2 decreased the helium flux by 20% (FIG. 7), but this was mostly because: (1) the helium partial pressure in the feed was reduced due to the high CO2 partial pressure required to obtain this activity, and (2) CO2 adsorption in the zeolite pores decreased helium flow through them. Higher CO2 partial pressures were required to achieve the same activities as for the other molecules because CO2 has a much higher vapor pressure. Note that at low activities CO2 appears to increase the helium flux. The increase is only a few percent however, and could be due to slight changes in the feed total pressure when CO2 was added to the helium feed.

Although not as many permporosimetry measurements were made for membrane 1 since its defects were larger and thus did not decrease as much with adsorption, the helium flux dependences on activity for n-pentane and n-hexane were similar, and showed similar trends to those for membrane 2. At the lowest activity used, 0.0015, the helium flux decreased to 6.7% for n-pentane and 6.3% for n-hexane, and then it decreased slightly more at higher activities.

### Defect Shrinkage Dependence on Alkane Loading

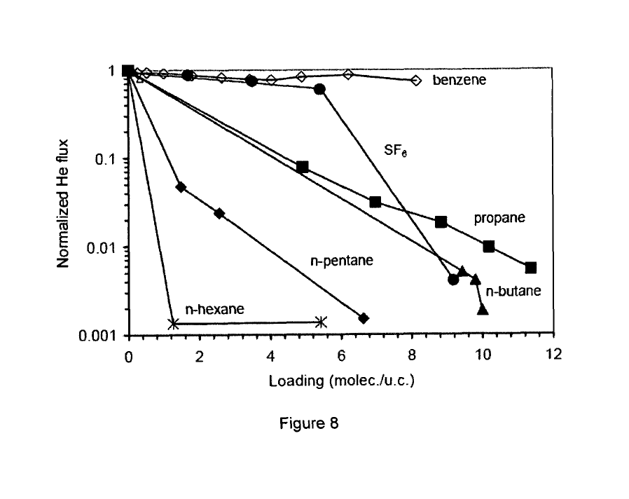

The large changes in helium flux during permporosimetry take place at low loadings (molec./u.c.) of the adsorbed molecules, as shown in FIG. 8. The loadings were calculated from adsorption isotherms reported in the literature (] R. Krishna, D. Paschek. Separation of hydrocarbon mixtures using zeolite membranes: a modelling approach combining molecular simulations with the Maxwell-Stefan theory. Sep. Purif. Technol. 21 (2000) 111; R. Krishna, B. Smit, S. Calero. Entropy effects during sorption of alkanes in zeolites. Chem. Soc. Rev. 31 (2002) 185; L. J. Song, L. V. C. Rees. Adsorption and diffusion of cyclic hydrocarbon in MFI-type zeolites studied by gravimetric and frequency-response techniques. Micropor. Mesopor. Mat. 35-36 (2000) 301). Even though the n-alkanes and SF6 all reduced the helium flux to less than 1% of its original value, the loadings needed to do this differ dramatically. The helium flux was reduced almost three orders of magnitude for a n-hexane loading of less than 0.4 molec./u.c.; the saturation loading of n hexane is 8 molec./u.c. In contrast, almost 7 molec./u.c. were required for n-pentane to decrease the flux this much, and its saturation loading is 9 molec./u.c. Ten n-butane molecules per unit cell (its saturation loading) were need to reduce the helium flux by almost three orders of magnitude. Propane, which has a saturation loading of 12 molec./u.c., had not reduced the helium flux this much even at a near-saturation loading of 11.5 molec./u.c. Although we have referenced XRD studies that show n-hexane and some of the other alkanes expand MFI crystals at saturation loadings, no data were found for crystal expansion at low loadings, and the effect of n-hexane at such low loadings is surprising. The helium flux behaved differently when SF6 adsorbed. Up to a SF6 loading of about 6 molec./u.c., the helium flux did not decrease much, but for about 9 molec./u.c., the helium flux decreased more than two orders of magnitude.

As seen in FIG. 8, benzene decreased the helium flux up to a loading of 4 molec./u.c., but for benzene loadings from 4 to 6 molec./u.c., the helium flux increased by 12%, and a repeat of this measurement confirmed this increase. This result could be due to an increase in the defect size because benzene adsorption shrank the MFI crystals over some loading range. Indeed benzene can shrink MFI crystals slightly in one direction (B. F. Mentzen, F. Lefebvre. Flexibility of the MFI silicalite framework upon benzene adsorption at higher pore-fillings: A study by X-ray powder diffraction, NMR and molecular mechanics. Mater. Res. Bull. 32 (1997) 813; and unpublished research), and we have recently observed that some molecules increase the helium flux above its value for the empty membrane.

### Single Gas Permeation

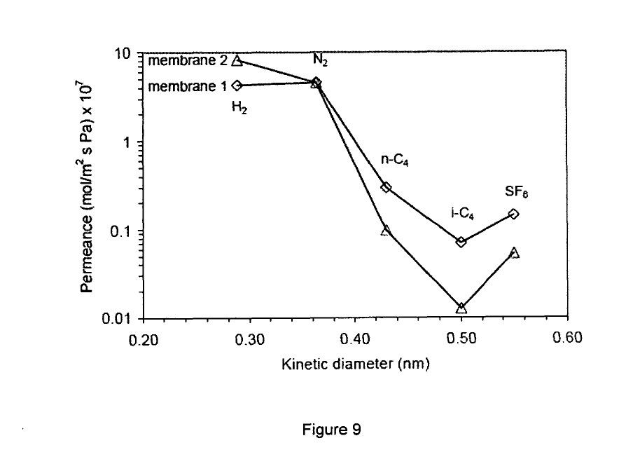

The single-gas permeances of H2, N2, SF6, n-butane, and i-butane were measured since these molecules have often been used to characterize MFI membranes. As shown in FIG. 9, the permeances at 96-kPa pressure drop, were for most conditions in the order: H2≧N2>n-butane>SF6>i-butane for both membranes.

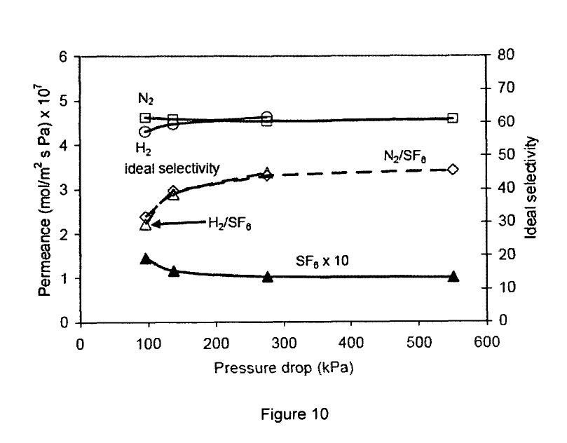

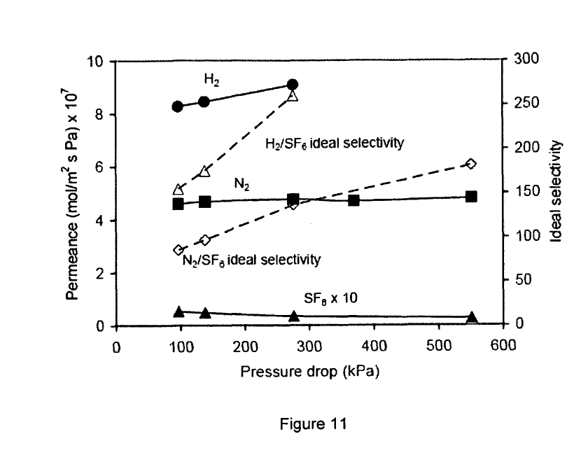

The H2, N2, and SF6 permeances exhibited weak dependencies on feed pressure as shown in FIG. 10 (membrane 1) and FIG. 11 (membrane 2). The H2/SF6 and N2/SF6 ideal selectivities (FIGS. 10 and 11) increased as the feed pressure increased because the H2 and N2 permeances increased linearly with pressure (their loadings in MFI pores were low), but the SF6 permeance did not. Doubling the SF6 feed pressure did not double its loading in MFI pores; SF6 adsorbed more strongly than H2 or N2 in MFI pores. The permeances also depended on the permeate pressures since the SF6 loading on the permeate side was much higher than that for N2, so the driving force for SF6 permeation was smaller. This contributes to the high H2/SF6 selectivities. Membrane 2, which had 90% of its helium flux through defects, had a H2/SF6 ideal selectivity of 250 at a feed pressure of 280 kPa (FIG. 11). Clearly, the H2/SF6 ideal selectivity is not a useful indication of membrane quality because SF6 swells the MR crystals and shrinks the defects. For membrane 1, the H2/SF6 selectivities were lower, and this is consistent with the measurements that indicated the defects in membrane 1 cannot be closed by crystal expansion.

The n-butane/1-butane ideal selectivities were 8 for both membranes (Table 2). The same selectivities for both membranes is rather surprising and further indicates that n-butane/1-butane ideal selectivity is not a good indication of membrane quality.

### Separations Properties

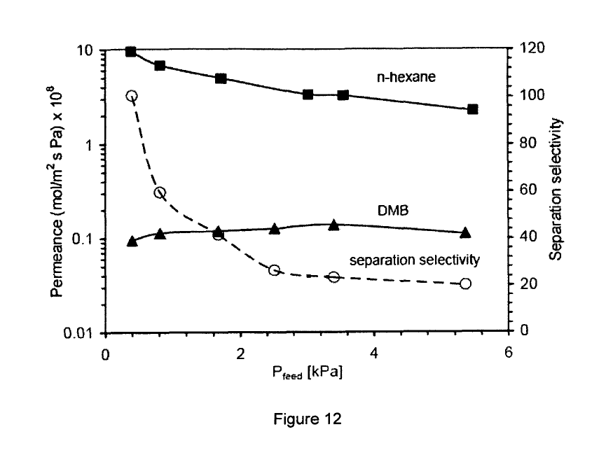

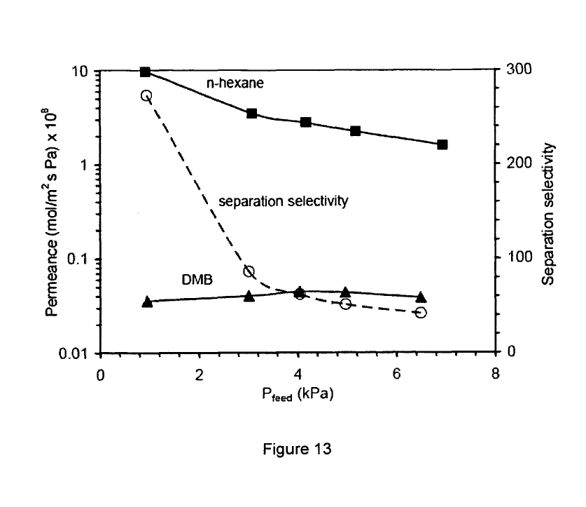

Even though both membranes had significant flow through defects, they separated mixtures that contained molecules that swell the MFI crystals. Both membranes selectively permeated n-hexane for 50/50 n-hexane/DMB vapor mixtures. As shown in FIG. 12, at low isomer pressures the n-hexane/DMB separation selectivity was about 100 for membrane 1, but this decreased to 20 at higher pressures. Similarly for membrane 2 (FIG. 13), the selectivity decreased from 260 at low pressures to 40 at higher pressures. The n-hexane fluxes were comparable in the two membranes, but the DMB fluxes were lower in membrane 2, and thus its selectivities were higher. Even though 90% of the helium permeated through defects in membrane 2 (in the absence of a crystal-swelling adsorbate), the n-hexane/DMB selectivity was 260 because n-hexane expanded the crystals and decreased flux through the pores.

### Membrane Characterization

High ideal and mixture selectivities reported in previous studies on MFI membranes may have been due in part to swelling of MFI crystals if these membranes had significant concentrations of defects and the mixture included molecules that swell MFI crystals. However, a membrane with significant flow through defects can still be effective for separations. Because the flow through defects becomes a larger fraction of the flow at higher feed concentrations (FIG. 5), separations should be done at high feed concentrations, such as during pervaporation, to obtain an accurate characterization of a membrane.

The results presented here demonstrate that the following methods may not discriminate between membranes with few or many defects: N2/SF6 or H2/SF6 single-gas ratios (ideal selectivities); n-butane/H2 or n-propane/H2 separations selectivity; n-butane/1-butane single ideal or separation selectivities; n-hexane permporosimetry; n-hexane/DMB separation selectivity at low partial pressures.

Instead, permporosimetry with benzene and n-hexane in separate measurements indicates the quantity of membrane defects and their pore sizes. Capillary condensation of molecules that only diffuse through defects, and pervaporation of large molecules also provide good characterizations of defects in MFI membranes. Permporosimetry measurements have the additional advantage of quantifying the fraction of flow through defects.

Note that the ability of adsorption to seal defects is a complicated function of the microstructure of the defects. Since the MFI crystals do not expand the same amount in each direction, membrane orientation will affect the ability of an adsorbed molecule to seal the defects, even for membranes with the same size defects. The membrane thickness and the presence of defects in series with MFI crystals, also affect how adsorption changes membrane properties.

Based on the above observations, several conclusions can be drawn about the two membranes investigated. The permporosimetry results and the capillary condensation measurements indicate that membrane 1 has larger defects than membrane 2. The number of these defects in membrane 1 is smaller than in membrane 2, however, so that only 9% of the helium permeated through these defects. These defects shrank, but were not sealed, when n-hexane (or other molecules) adsorbed. This membrane would be expected to have higher separation selectivities than membrane 2 for mixtures that do not contain a molecule that swells the crystals. Selectivity would be expected to be less at higher concentrations because the defects contribute more to the flux when molecules condense in them.

Membrane 2 has smaller defects, but many more of them so it would not be a selective membrane for mixtures that do not contain a molecule that swells the crystals. The flux through the defects dramatically decreased when n-hexane (and other molecules) adsorbed, so that this membrane could be selective for mixtures that contain one of these molecules. A membrane with few defects would also have high ideal and separation selectivities for the molecule used in this study, but many of the characterization methods that have been used in previous studies could not distinguish this type membrane from membrane 2. For example, a low helium flux during permporosimetry when n-hexane adsorbs is necessary for a good membrane, but not sufficient. In addition, the vapor permeation measurements and C6 isomer separations show that defects have more influence on permeation properties at high feed concentrations. A membrane can have high selectivities at low feed concentrations, but low selectivities (or no selectivity) at high feed concentrations because the flux through the defects increases much more with feed concentration than the flux through the MFI pores.

Membranes 1 and 2 may not represent most MFI membranes reported in the literature, but these results illustrate that many membranes in the literature were characterized by methods that do not discriminate between membranes with few or many defects. Whether adsorption can close the defects and improve the membrane quality depends on the size of the defects.

### CONCLUSIONS

Comparing two membranes with different microstructures indicates that many methods used previously in the literature (n-hexane permporosimetry; H2/SF6, N2/SF6, and n-butane/1-butane ideal selectivities; n-hexane/DMB separation selectivity; n-propane/H2 or n-butane/H2 separation selectivity) to characterize MFI membranes are inadequate for assessing membrane quality. These methods cannot discriminate between membranes with few defects and ones with many defects.

Our studies show that n-propane, n-butane, n-pentane, n-hexane, and SF6 swell MFI crystals, and the swelling decreases the size of defects. In contrast, benzene and CO2 do not swell MFI crystals and thus benzene permporosimetry provides a good measure of flow through defects. These studies also show that membranes with significant flow through defects can be highly selective for separating some gas mixtures, if the defects are small enough and one of the molecules in the mixture swells the crystals.

1. A method for controlling the flow of a first component through a crystalline molecular sieve membrane, the method comprising the steps of:
a) providing a crystalline molecular sieve membrane comprising zeolite pores and non-zeolite pores;
b) adsorbing an effective amount of a second component in the zeolite pores, the second component being capable of expanding the molecular sieve crystals in at least one dimension, wherein the permeance of the first component through the membrane in the presence of the second component is less than or equal to 10% of the permeance in the absence of the second component.

2. The method of claim 1, wherein the permeance in the presence of the second component is less than or equal to 1% of the permeance in the absence of the second component.

3. The method of claim 1, wherein the size of the zeolite pores is such that transport of the molecules of the first component occurs primarily through the non-zeolite pores and permeance of the first component through the membrane is greater than greater than or equal to 1×10⁻¹⁰ mol/m²sPa in the absence of the second component.

4. The method of claim 1, wherein the loading of the second component within the zeolite pores is less than or equal to its saturation value.

5. The method of claim 1, further comprising the step of desorbing at least a portion of the adsorbed second component, thereby increasing the permeance of the first component through the membrane.

6. The method of claim 1, wherein the molecular sieve crystals have the MFI structure.

7. The method of claim 6, wherein the second component is a linear alkane having at least three carbon atoms.

8. The method of claim 7, wherein the second component has from three to eight carbon atoms.

9. The method of claim 6, wherein the second component is SF₆.

10. A method for storing and dispensing molecules of a first substance, the method comprising the steps of:
a. providing a crystalline molecular sieve membrane disposed across an access port of a storage and dispensing vessel, the membrane comprising zeolite and non-zeolite pores;
b. introducing molecules of the first substance into the storage and dispensing vessel;
c. placing the layer in a first state through adsorption of an effective amount of molecules of a second substance within the zeolite pores of the crystals, the second component being capable of expanding the molecular sieve crystals in at least one dimension; and
d. placing the layer in a second state through desorption of the second substance
wherein when the membrane is in the first state, the permeance of molecules of the first substance across the membrane is less than the permeance of molecules of said molecules across the membrane in the second state.

11. The method of claim 10, wherein the permeance in the first state is less than or equal to 10% of the permeance in the second state.

12. The method of claim 11, wherein the permeance in the first state is less than or equal to 1% of the permeance in the second state.

13. The method of claim 10, wherein the molecules of the first component are shaped and sized so that its transport through the membrane occurs primarily through the non-zeolite pores.

14. The method of claim 10, wherein the molecular sieve crystals have the MFI structure.

15. The method of claim 14, wherein the second component is a linear alkane having at least three carbon atoms.

16. The method of claim 15, wherein the second component has from three to eight carbon atoms.

17. The method of claim 10, wherein the second component is SF₆

18. A pellet for storing molecules of a first substance, the pellet comprising
a. a particle comprising molecules of the first substance adsorbed within the particle; and
b. a layer of interconnected molecular sieve crystals enclosing the particle and comprising
i) zeolite pores,
ii) nonzeolite pores; and
iii) molecules of a second substance adsorbed within the molecular sieve pores of the crystals, the second component being capable of expanding the molecular sieve crystals in at least one dimension and the amount of the second substance being effective to restrict transport of the molecules of the first substance through said layer.

19. The pellet of claim 18, wherein the molecules of the first substance are shaped and sized so that its transport occurs primarily through the non-zeolite pores.

20. The pellet of claim 18, wherein the molecular crystals have the MFI structure.

21. The pellet of claim 20, wherein the second substance is selected from the group consisting of linear alkanes having at least 3 carbon atoms.

22. The pellet of claim 21, wherein the second substance has from three to eight carbon atoms.

23. The pellet of claim 20, wherein the second substance is SF₆.
